(19) United States
(12) Patent Application Publication
(10) Pub. No.: US 2013/0044679 A1
(43) Pub. Date: Feb. 21, 2013

(54) System and Methods for Handling an IP Dual-Stack Connection

(71) Applicants: Béla Rathonyi, Lomma (SE); Marcus Davidsson, Lund (SE); Harald Johansen, Rykene (NO); Jia Li, Beijing (CN)

(72) Inventors: Béla Rathonyi, Lomma (SE); Marcus Davidsson, Lund (SE); Harald Johansen, Rykene (NO); Jia Li, Beijing (CN)

(21) Appl. No.: 13/334,750

(22) Filed: Dec. 22, 2011

Related U.S. Application Data
(60) Provisional application No. 61/525,541, filed on Aug. 19, 2011.

(51) Int. Cl. H04W 76/00

(52) U.S. Cl. 370/328

(57) ABSTRACT

In a mobile device operative in a packet switched wireless network, the control logic for handling the PS connection resides inside the modem part of the device when dual-stack operation is required (e.g., PDN connections having PDN types IPv4 and IPv6). This effectively hides how dual-stack IPv4v6 connectivity is implemented towards the relevant 3GPP network. Further, the modem always only uses one and only one network interface, as seen from the IP stack, when it operates in dual-stack mode, regardless of how the underlying PDN connection(s) are set up.

The present invention claims priority to U.S. Provisional Patent Application No. 61/525,541, titled “Systems and Methods for Handling an IP Dual-Stack Connection,” filed Aug. 19, 2011, the disclosure of which is incorporated herein by reference in its entirety.

### TECHNICAL FIELD

The present invention relates generally to wireless communication equipment User Equipment, and in particular to management of IPv4, IPv6, and IPv4v6 PDN connections.

### BACKGROUND

A dramatic increase in so-called smartphone devices receiving data connection services from wireless communications systems has dramatically increased the amount of Internet Protocol (IP) traffic transmitted over wireless communication systems. Version 4 of the IP protocol (IPv4) is the most widely deployed. IPv4 uses 32-bit addresses to identify the source and destination of network traffic, yielding 4,294,967,296 (2³²) unique addresses. Large blocks of these addresses are reserved, e.g., 18 million for private networks and 270 million for multicast operations. The number of addresses remaining for routing traffic among wireless networks and the Internet is widely anticipated to be exhausted in time.

Version 6 of the IP protocol (IPv6) has been in development since the 1990s, but presently is deployed in only a limited fashion. IPv6 uses 128-bit addresses, and hence can support 2¹²⁸ addresses (approximately 3.4×10³⁸). IPv6 additionally include numerous other features, such as stateless address autoconfiguration, which will simplify network operations and improve their speed and efficiency. Due to the very large infrastructure upgrade necessary to implement IPv6, the IPv4 and IPv6 protocols are expected to co-exist, and must work together, for an extended duration of time.

For a mobile device to obtain IP connectivity towards a 3GPP-specified mobile network, a packet-switched (PS) connection must be set up towards the core network, where for example the IP address(es) to be used are obtained. This PS connection is denominated differently depending on whether the access is towards a GSM/WCDMA or an LTE based network. For GSM/WCDMA, the core network is the General Packet Radio Service (GPRS), and the PS connection is referred to as a Packet Data Protocol (PDP) context (sometimes also called a Primary PDP context, although “Primary” strictly refers only to the L3/SM procedure used). For LTE, the core network is the Evolved Packet System (EPS) and the PS connection is referred to as a Packet Data Network (PDN) connection.

From the point of view of the IP stack, executed on the mobile device host processor, a PS connection is equivalent to a network interface. Furthermore, there is no difference whether it is a “PDP context” (2G/3G) or a “PDN connection” (LTE), because the IP stack is unaware of the underlying access technology used. The IP-versions of the packets that can be transmitted and received on this network interface are one of the following: IPv4, IPv6, or both IPv4 and IPv6. These are referred to herein as PDP/PDN types or simply PDN types, and the case of PDN type IPv4 and IPv6 together is referred to herein as IPv4v6.

The simultaneous support of both IPv4 and IPv6 in an IP stack is often referred to as dual-stack. The PDP/PDN type IPv4v6 is targeting the dual-stack scenario but a dual-stack can also use one PDP/PDN type IPv4 and one PDP/PDN type IPv6. Different operator networks will support different deployments of this, and it will even change over time as networks are upgraded to add support for IPv6. Furthermore, the same operator network may support IPv6 in only some parts of their network, but not in other parts.

General information on IPv4 and IPv6 as relates to wireless networks may be found, e.g., in 3GPP TS 23.060, TS 23.401, and the IETF draft submission “IPv6 in 3GPP Evolved Packet System” (draft-ietf-v6ops-3gpp-eps-01) by Korhonen, et al., the disclosures of all of which are incorporated herein by reference in their entirety.

FIG. 1 depicts an overview of the typical components within a mobile device 10 that handles PS services from a 3GPP based network 12. Applications 14 (also known as “apps”) execute on an application processor (not shown, also known as a host processor), and establish data communications through a socket interface to an IP stack 16. As known in the art, the IP stack 16 is a software construct that maintains the assignment of port numbers to applications 14. Conventionally, a functional unit referred to as a PS connection manager 18 controls the set-up of PS connections towards a modem 20 on the device, over a control plane interface. The modem 20 includes circuits and software operative to communicate with the network 12 via one or more antennas 22. The PS connection manager 18 also configures the IP stack 16 with the IP address(es) to be used, over a control interface. The IP Stack 16 then uses a user plane interface to send/receive IP packets to/from the modem 20.

Typically, apps 14, the IP stack 16, and PS connection manager 18 are implemented as functional software modules executing on an application processor (not shown) in the mobile device 10. The application processor is separate from the modem 20, which may include a separate processor (not shown) and execute separate software routines. This division is indicated by the dotted line in FIG. 1.

From the perspective of the IP stack 16, the user plane interface is known as the network interface. Currently, the routing of IP packets to a specific interface is based on the IP address (or IPv6 prefix). Accordingly, if there are two Packet Data Network (PDN) connections active towards the network 12—for example, one of type IPv4 and one of type IPv6—there are two network interfaces used in the IP stack 16. This situation is depicted in FIG. 2. There are several deficiencies associated with this dual-stack IP configuration.

First, the PS connection manager 18 must have detailed knowledge of specifics of the deployment of IPv6 in the network 12. Depending on the availability, and error codes sent to protocols inside the modem 20 from the network 12, it must for example have control logic to attempt to set up an additional PDN connection in case the type IPv4v6 is not supported by the network 12. Furthermore, the PS connection manager 18 may need to obtain information from the modem 20 regarding whether the active radio access technology (RAT) is using GPRS or EPS, and potentially have different behavior based on this information.

Second, from the perspective of the IP stack 16, the dual-stack operations must be supported both using one and two network interfaces (i.e., user plane interfaces to the modem 20).

Third, when two network interfaces are used to handle dual-stack operations, more processing resources are consumed within the mobile device 10, compared to the case where only one network interface is used. This applies both to the application CPU and the modem CPU, as well as the interface transport between the CPUs.

Thus, there remains a need for an improved configuration and methodology to support both IPv4 and IPv6 without the need for a dual-stack form of IP stack 16 in mobile devices 10.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure is not intended to identify key/critical elements of embodiments of the invention or delineate the scope of the invention. The sole purpose of this summary is to present some concepts disclosed herein in a simplified form as a prelude to the more detailed description that is presented later.

According to embodiments of the present invention, the control logic for establishing and maintaining PDN connections to the network resides inside the modem of the device when dual-stack operation is required. This effectively hides, from apps and the IP stack, how dual-stack IPv4v6 connectivity is implemented towards the relevant 3GPP network. Further, the modem always only presents one and only one network interface to the IP stack when it operates in dual-stack mode, regardless of how the underlying PDN connection(s) are set up.

One embodiment relates to a method, performed in a modem of a mobile device, of establishing PDN connections with a wireless network. A request to establish a PDN connection with the wireless network of PDN type IPv4v6 is received from a packet switched connection manager executing on a host processor of the mobile device. In response to the request from the packet switched connection manager, a request for a PDN connection having a PDN type IPv4v6 is transmitted to the wireless network. One or more PDN connections to the network are established, enabling the exchange of both IPv4 and IPv6 packets with the network. A single user plane interface of PDN type IPv4v6 to an IP stack is established.

Another embodiment relates to a method, performed in a modem of a mobile device, of establishing linked PDN connections with a wireless network. A request to establish a PDN connection with the wireless network is received from a packet switched connection manager executing on a host processor of the mobile device, the request specifying one of a PDN type IPv4 and a PDN type IPv6, and further identifying an existing PDN connection having the other of a PDN type IPv4 and a PDN type IPv6. In response to the request from the packet switched connection manager, a request for a PDN connection having the requested PDN type is transmitted to the wireless network. An acceptance of the request for a PDN connection having the requested PDN type is received from the wireless network. In response to the acceptance from the wireless network, a new PDN connection having the same user plane endpoint to an IP stack as the existing PDN connection is established. An indication of the linked PDN connections with the wireless network is sent to the packet switched connection manager.

Yet another embodiment relates to a method, performed in a modem of a mobile device, of routing uplink data packets to a wireless network. A plurality of IP packets of version IPv4 and/or IPv6 are received on a single user plane interface of type IPv4v6, from an IP stack executing on a host processor of the mobile device. For each received IP packet, whether the packet is of version IPv4 or IPv6 is ascertained. IPv4 packets are transmitted to the network on a PDN connection of type IPv4, and IPv6 packets are transmitted to the network on a PDN connection of type IPv6.

Still another embodiment relates to a mobile device operative to communicate via a packet switched wireless communication network. The device includes a host processor executing a packet switched connection manager operative to initiate and manage packet data network (PDN) connections to the wireless network. The device also includes a modem comprising a transceiver operative to transmit data to, and receive data from, the wireless network; and control logic. The control logic is operative to receive, from a packet switched connection manager executing on a host processor of the mobile device, a request to establish a PDN connection with the wireless network of PDN type IPv4v6; in response to the request from the packet switched connection manager, establish a single user plane interface of PDN type IPv4v6 to an IP stack; in response to the request from the packet switched connection manager, transmit a request for a PDN connection having a PDN type IPv4v6 to the wireless network; and establish one or more PDN connections to the network, enabling the exchange of both IPv4 and IPv6 packets with the network.

Still another embodiment relates to a mobile device operative to communicate via a packet switched wireless communication network. The device includes a host processor executing a packet switched connection manager operative to initiate and manage packet data network (PDN) connections to the wireless network. The device also includes a modem comprising a transceiver operative to transmit data to, and receive data from, the wireless network; and control logic. The control logic is operative to receive, from a packet switched connection manager executing on a host processor of the mobile device, a request to establish a PDN connection with the wireless network, the request specifying one of a PDN type IPv4 and a PDN type IPv6, and further identifying an existing PDN connection having the other of a PDN type IPv4 and a PDN type IPv6; in response to the request from the packet switched connection manager, transmit a request for a PDN connection having the requested PDN type to the wireless network; receive, from the wireless network, an acceptance of the request for a PDN connection having the requested PDN type; in response to the acceptance from the wireless network, establish a new PDN connection having the same user plane endpoint to an IP stack as the existing PDN connection; and send to the packet switched connection manager an indication of the linked PDN connections with the wireless network.

Still another embodiment relates to a mobile device operative to communicate via a packet switched wireless communication network. The device includes a host processor executing a packet switched connection manager operative to initiate and manage packet data network (PDN) connections to the wireless network. The device also includes a modem comprising a transceiver operative to transmit data to, and receive data from, the wireless network; and control logic. The control logic is operative to receive, from an IP stack executing on a host processor of the mobile device, a plurality of IP packets of version IPv4 and/or IPv6 on a single user plane interface of type IPv4v6; ascertain, for each received IP packet, whether the packet is of version IPv4 or IPv6; transmit IPv4 packets to the network on a PDN connection of type IPv4; and transmit IPv6 packets to the network on a PDN connection of type IPv6.

### BRIEF DESCRIPTION OF THE DRAWINGS

FIG. 1 is a functional block diagram of a mobile device using PS services from a 3GPP network, according to the prior art.

FIG. 2 is a functional block diagram depicting the use of separate network interfaces for multiple PDN connections in the mobile device of FIG. 1, according to the prior art.

FIG. 3 is a functional block diagram of a mobile device using PS services from a 3GPP network, according to embodiments of the present invention.

FIG. 4A is a functional block diagram depicting the use of a single network interface for an IPv4v6 PDN connection to the network, in the mobile device of FIG. 2.

FIG. 4B is a functional block diagram depicting the use of a single network interface for separate IPv4 and IPv6 PDN connections to the network, in the mobile device of FIG. 2.

FIG. 5 is a flow diagram of a method of establishing PDN connections by the mobile device of FIG. 2.

FIG. 6 depicts a message sequence demonstrating a modem establishing an IPv4v6 connection with minimal communication to the PS Connection Manager.

FIG. 7 depicts a message sequence demonstrating a modem requesting an IPv4v6 connection and the request being accepted, with more detailed communication to the PS Connection Manager.

FIG. 8 depicts a message sequence demonstrating a modem requesting an IPv4v6 connection and the request being rejected; the modem then requesting IPv4 and IPv6 connections, which are accepted.

FIG. 9 depicts a message sequence demonstrating a modem requesting an IPv4v6 connection and the request being rejected; the modem then requesting an IPv4 connection which is rejected and an IPv6 connection, which is accepted.

FIG. 10 depicts a message sequence demonstrating a modem requesting an IPv4v6 connection and the request being accepted as an IPv4 connection; the modem then requesting an IPv6 connection which is rejected.

FIG. 11 depicts a message sequence demonstrating a modem requesting an IPv4v6 connection and the request being accepted as an IPv4 connection; the modem then requesting an IPv6 connection which is accepted.

FIG. 12 depicts a message sequence demonstrating a modem requesting an IPv4v6 connection and the request being rejected; the modem then requesting an IPv4 connection which is rejected and an IPv6 connection which is rejected.

FIG. 13 depicts a message sequence demonstrating a modem requesting an IPv6 connection which is accepted, and the modem then linking the new IPv6 connection to an existing IPv4 connection user plane endpoint.

FIG. 14A depicts the header format of an IPv4 packet.

FIG. 14B depicts the header format of an IPv6 packet.

FIG. 15 is a flow diagram of a method of routing uplink IP packets.

FIG. 16 is a functional block diagram of a mobile device.

### DETAILED DESCRIPTION

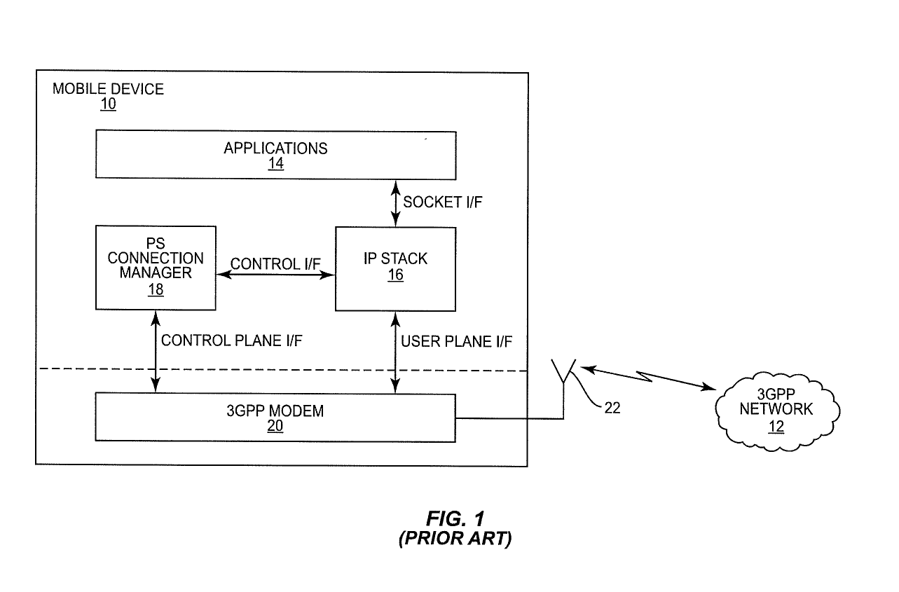

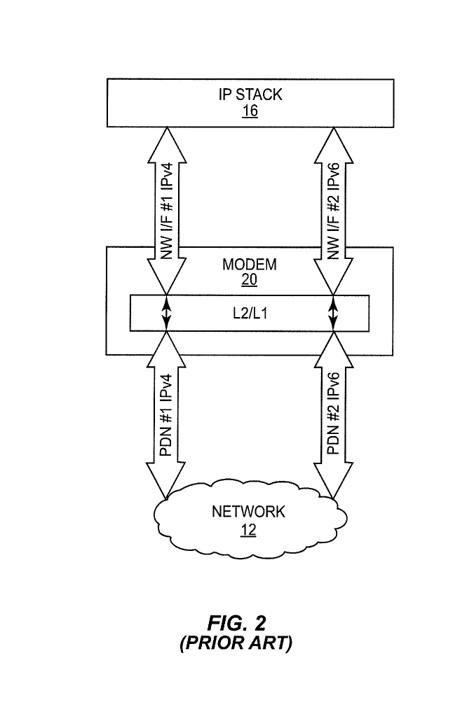

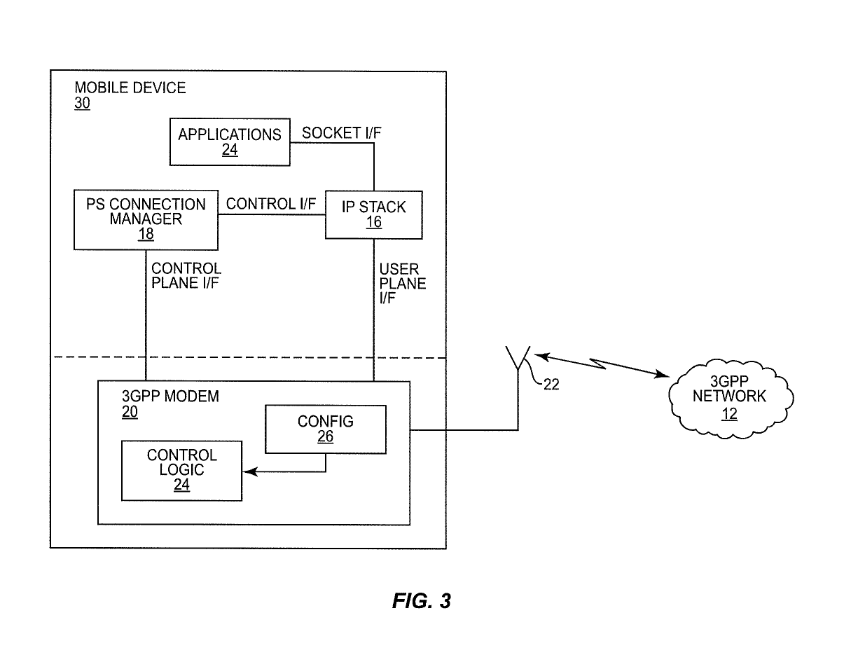

FIG. 3 depicts a mobile device according to embodiments of the present invention. The mobile device 30 includes the same host processor applications 14, IP stack 16, and PS connection manager 18 as depicted in FIG. 1 (and hence is backward compatible with many mobile devices). Within the modem 20 is control logic 24 to handle requested PDN connections for all PDP/PDN type requests from the IP stack 16, according to configuration data 26. In particular, the control logic 24 provides two mechanisms to hide the underlying network 12 deployment for a client requesting an IPv4v6 connection.

First, if an IPv4v6 type is rejected (or partly rejected) by the network 12, the control logic 24 may autonomously trigger the activation towards the network 12 of additional PDN connections, if allowed by received message contents from the network 12. In this case, the control logic 24 attempts to fully exhaust the establishment of requested PDN connections before replying to the PS connection manager 18. Alternatively, the communication with the PS connection manager 18 may be more frequent, e.g., the control logic 24 may relay the results of each network request.

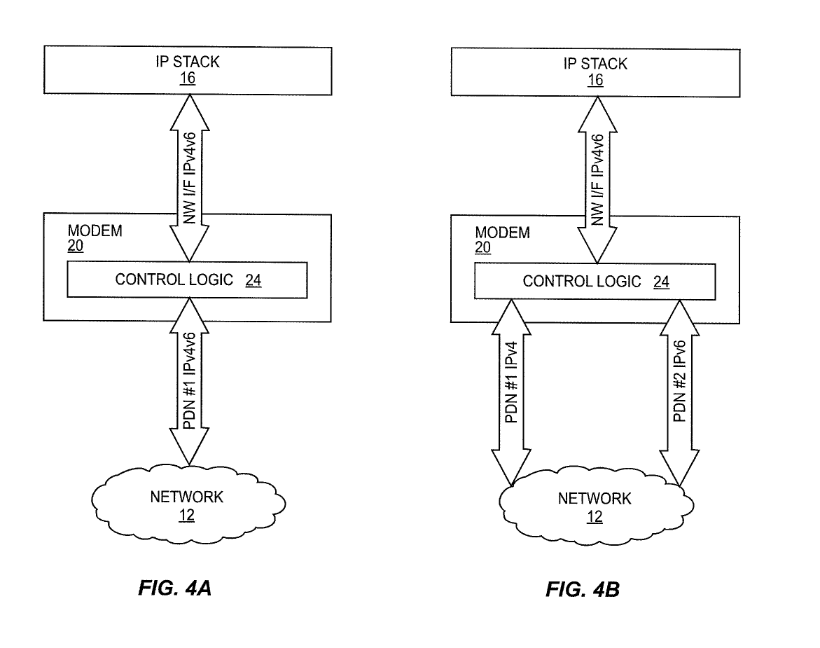

Second, the control logic 24 sets up only one user plane endpoint for transferring both IPv4 and IPv6 packets between an IP stack 16 and the modem 20, regardless of whether the attempt to set up the IPv4v6 connection results in one or two PDN connections active towards the network 12. The IP stack 16 thus only uses one network interface in either case. FIGS. 4A and 4B depict these two cases.

In FIG. 4A, the control logic 24 within the modem 20 is successful in establishing a PDN connection to the network 12 of type IPv4v6. The control logic 24 provides a single user plane network interface to the IP stack 16, on which both IPv4 and IPv6 traffic is routed.

In FIG. 4B, the network 12 does not support a single PDN connection handling both IPv4 and IPv6 traffic. Accordingly, the control logic 24 within the modem 20 established two separate PDN connections to the network 12—one of type IPv4 and another of type IPv6. However, the control logic 24 still provides only a single user plane network interface to the IP stack 16, on which both IPv4 and IPv6 traffic is routed. In this manner, the IP stack 16 need not establish and maintain a complex “dual-stack” structure and function. Rather, the control logic 24 hides the details of the network 12 connections, simplifying data communication processing by the PS connection manager 18 and IP stack 16.

The control logic 24 may establish the dual PDN connections to the network 12 by implementing an autonomous re-try protocol. When a client requests the activation of a PDN connection of type IPv4v6, and the resulting attempt by the modem 20 fails, the control logic 24 implements a re-try mechanism. This re-try mechanism is preferably configurable, but can of course also be hard-coded. If configurable, the configuration data 26 can, e.g., be stored in a non-volatile memory; be part of a software build configuration; or be dynamically set by messages sent to the modem 20, for example, as a separate parameter when the PS connection manager 18 requests the set-up of an IPv4v6 connection. In one embodiment, the re-try configuration parameter may have five different values:
a) Automatic re-try to get access to both IPv4 and IPv6 but try IPv4 first and then IPv6.
b) Automatic re-try to get access to both IPv4 and IPv6 but try IPv6 first and then IPv4.
c) Automatic re-try to get access to only IPv4.
d) Automatic re-try to get access to only IPv6.
e) No automatic re-try.

If any of parameter values a) through d) is configured, in one embodiment the control logic 24 controls the modem 20 to initiate new PDN connection set-up requests to the network 12 autonomously, without informing the PS connection manager 18 until the re-try mechanisms have completed. This is done based on the configured value and the cause values received from the network 12. In another embodiment, the control logic 24 makes the re-try attempts, sends status messages to the PS manager 18, informing it of the success or failure of each network request. If the parameter value e) is configured, the control logic 24 will not initiate any re-try attempts, and will then inform the PS connection manager 18 of the failure of setting up the requested IPv4v6 connection. Thus, the PS connection manager 18 may completely disable all re-tries by configuring the control logic 24 with parameter value e).

Two main different scenarios exist when an IPv4v6 set-up request is not accepted by the network 12, and the control logic 24 behavior then depends on the configured value a)-e) in the following way. Note, however, that a potential cause value received from the network 12 may lead to other behavior, and will have precedence over the configured re-try mechanism. Thus, the re-try described below is only performed if it is allowed. Scenarios wherein the behavior described herein is overridden are not discussed further.

First, the IPv4v6 connection request may be completely rejected. That is, no PDN connection exists. In this case, the control logic 24 behavior is as follows (corresponding to the above-described configured parameter values):
a) The control logic 24 requests two new PDN connections using the same parameters except for the PDN type. The PDN type is first changed to IPv4, and then IPv6.
b) The control logic 24 requests two new PDN connections using the same parameters except for the PDN type. The PDN type is first changed to IPv6, and then IPv4.
c) The control logic 24 requests one new PDN connection using the same parameters except for the PDN type. The PDN type is changed to IPv4.
d) The control logic 24 requests one new PDN connection using the same parameters except for the PDN type. The PDN type is changed to IPv6.
e) No new request is sent to the network 12.

Second, the connection request is successful, but the PDN type was changed to either IPv4 or IPv6 by the network 12. That is, one PDN connection exists. In this case, the control logic 24 behavior is as follows (corresponding to the above-described configured parameter values):
a) The control logic 24 requests a new PDN connection using the same parameters except for the PDN type. The PDN type is set to the protocol version that was not accepted from the first request (i.e., if IPv4 was accepted, request IPv6, and vise versa).
b) Same as a).
c) No action is taken.
d) No action is taken.
e) No action is taken.

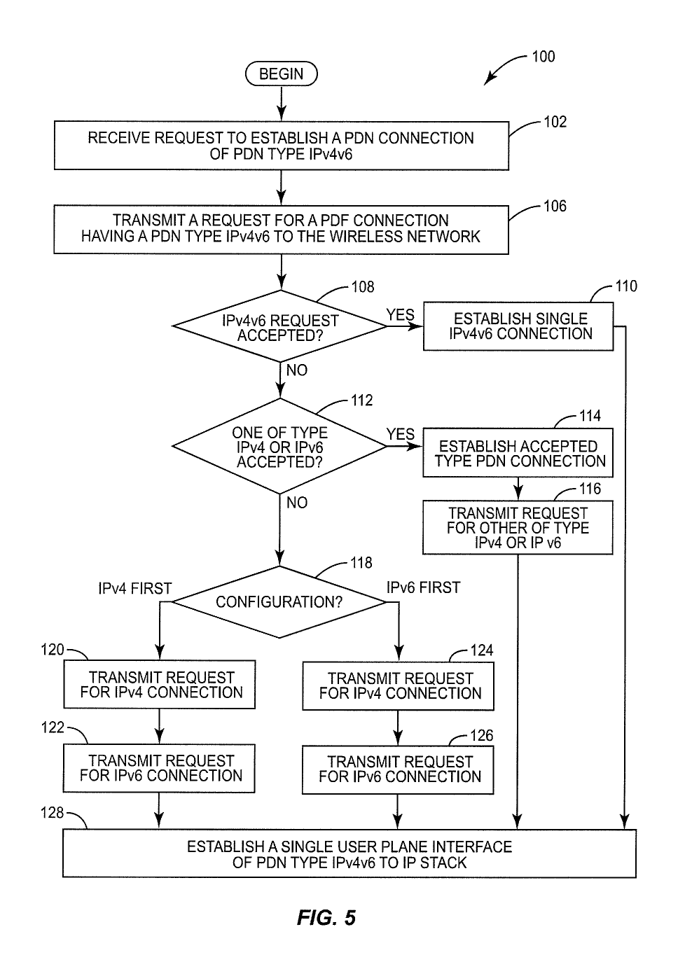

FIG. 5 depicts a method 100, executed by control logic 24 in the modem 20 of a mobile device 30 according to one embodiment. The control logic 24 receives a request from a PS connection manager 18 to establish a PDN connection to the network 12 of type IPv4v6 (block 102). The control logic 24 transmits a request to the network 12 for a PDN connection of type IPv4v6 (block 106). If the network 12 accept the request (block 108), the control logic 24 establishes the single IPv4v6 connection (block 110), and reports this result to the PS connection manager 18. The control logic 24 then establishes a single network, or user plane, interface with the IP stack 16 (block 128).

If, however, the network 12 rejects the IPv4v6 connection request, but indicates acceptance of a PDN connection having either type IPv4 or IPv6 (block 112), then the control logic 24 establishes a PDN connection of the accepted type (block 114). The control logic 24 subsequently transmits a second request, for a PDN connection of the other (non-accepted) type (block 116). If this request is accepted, the control logic 24 establishes the second PDN connection (not shown), and operates both the IPv4 and IPv6 PDN connections, presenting only a single user plane endpoint (IPv4v6) to the IP stack 16. In this case also, the control logic 24 establishes a single user plane interface with the IP stack 16 (block 128).

If the network 12 rejected the IPv4v6 request (block 108), and did not accept either an IPv4 or IPv6 connection (block 12), then the control logic 24 action depends on its configured value (block 118). If the control logic 24 is configured to first attempt an IPv4 connection (block 118), it transmits a request for a PDN connection of type IPv4 (block 120), followed by a request for a PDN connection of type IPv6 (block 122). Conversely, if the control logic 24 is configured to first attempt an IPv6 connection (block 118), it transmits a request for a PDN connection of type IPv6 (block 124), followed by a request for a PDN connection of type IPv4 (block 126). In either case, in one embodiment the PS connection manager 18 is only informed of the resulting PDN connections after the relevant requests have been transmitted to, and answered by, the network 12. Further, in either case, if both PDN connection types are established with the network 12, then the control logic 24 establishes a single user plane interface with the IP stack 16 (block 128).

Assuming the relevant network 12 requests are successful/accepted, then following blocks 110, 116, 122, or 126 in the method 100, the mobile device 30 has either a single IPv4v6 PDN connection to the network 12 (as depicted in FIG. 4A), or both of an IPv4 and an IPv6 PDN connection (as depicted in FIG. 4B). In either case, only a single network interface, or user plane endpoint, of type IPv4v6, is established between the IP stack 16 and the control logic 24 (as indicated by all of blocks 110, 116, 122, and 126 terminating at block 128).

The common user plane can also be achieved in another manner—by explicit request from the PS connection manager 18. The PS connection manager 18 may request to activate a new PDN connection with an indication that the new connection should use the same user plane endpoint as a previously activated PDN connection. Thus, the new PDN connection is linked to an existing one. This may, for example, be done by providing an existing user plane identity (UP_Id) in the request to activate the new PDN connection. The control logic 24 only supports linking two user plane connections into one endpoint if they have PDN types of one IPv4 and one IPv6. If this is not the case, the control logic 24 will reject the request to set-up the linked PDN connection.

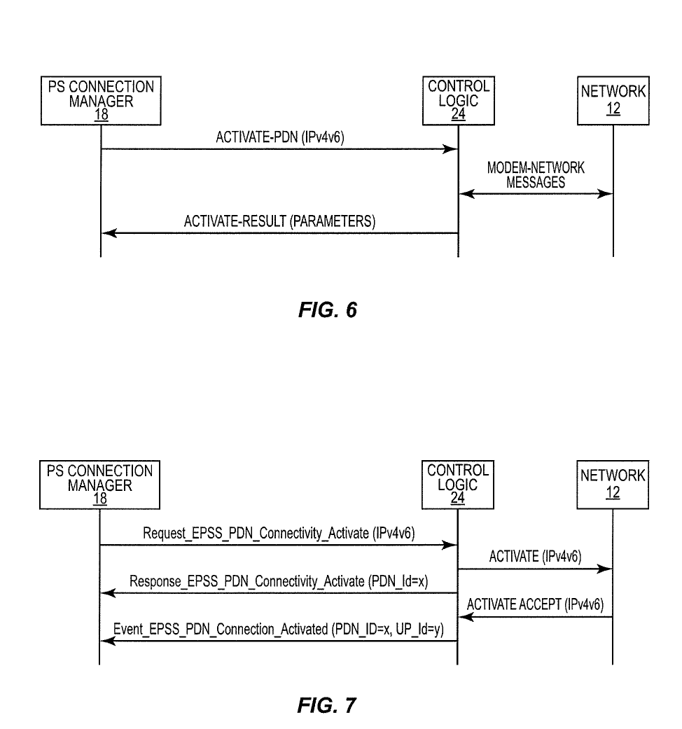

As described above, in various embodiments the degree of communication between the control logic 24 and the PS Connection Manager 18 may vary. FIG. 6 depicts an embodiment wherein the control logic 24 acts autonomously, with communication to the PS Connection Manager 18 only after the PDN connection to the network 12 is established. Initially, the PS Connection Manager 18 sends the control logic 24 a request for an IPv4v6 connection. The control logic 24 negotiates with the network 12 to establish either a single IPv4v6 PDN connection, or separate IPv4 and IPv6 connections. Only after the PDN connection(s) to the network 12 are established does the control logic 24 notify the PS Connection Manager 18 of the result.

FIGS. 7-13 depict another embodiment, in which the control logic 24 provides more detailed communications to the PS Connection Manager 18, informing it of the results of each request sent to the network 12. Various transactions are depicted. In some embodiments, the degree of communication from the control logic 24 to the PS Connection Manager 18 may be set dynamically, e.g. by parameter value or mode selection. For clarity, in all of FIGS. 6-12, the configuration is set to parameter value a)—that is, automatic re-try of IPv4 first. However, the same diagrams apply to configuration parameter value b) by simply exchanging the IPv4 and IPv6 identifiers in the relevant messages.

FIG. 7 depicts the case in which a PDN type IPv4v6 request is accepted and a PDN connection established. This is not considered in case a)-e) above, which consider only control logic 24 responses to a rejection of an IPv4v6 request or partially accepted by changing the PDN type to IPv4 or IPv6.

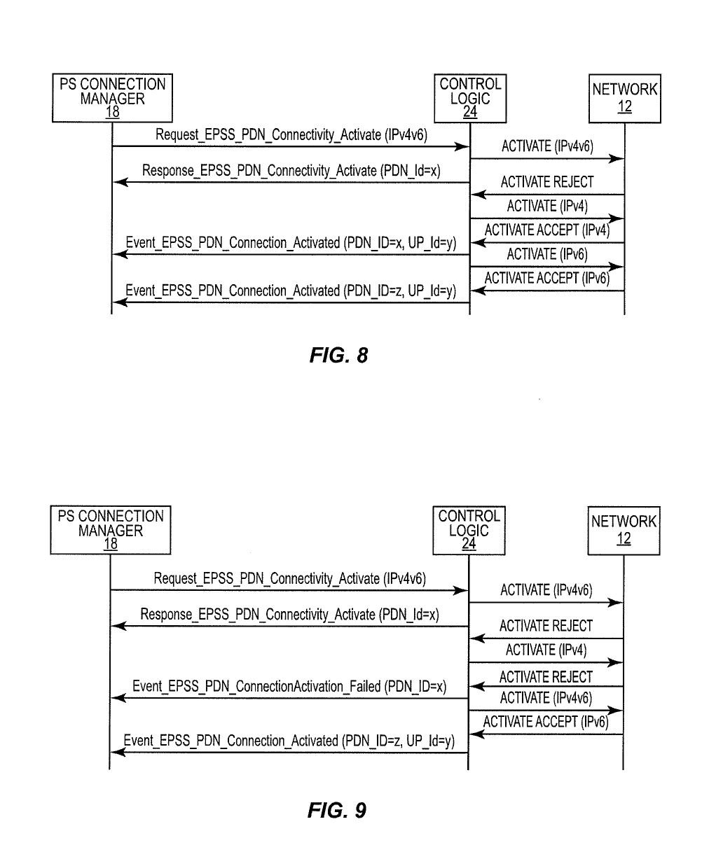

FIG. 8 depicts one case in which a PDN type IPv4v6 request is rejected. A PDN type IPv4 request is then issued, which is accepted, and a PDN type IPv6 request is then issued, which is also accepted. This results in two PDN connections activated, sharing the same user plane endpoint to the IP stack 16. This is the first case, result a) described above.

FIG. 9 depicts another case in which the PDN type IPv4v6 request is rejected. The control logic 24 then requests a PDN type IPv4 connection, which is also rejected. The control logic 24 then requests a PDN type IPv6 connection, which is accepted. In this case (reject, reject, accept) only one PDN connection is established.

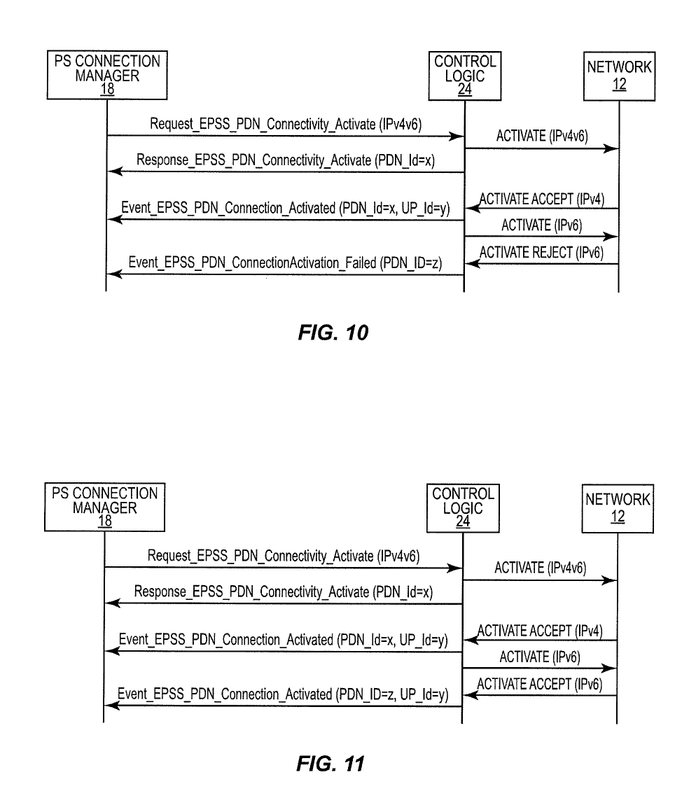

FIG. 10 depicts a case in which the PDN type IPv4v6 request is not rejected, but only an IPv4 connection is accepted. The control logic 24 then requests a PDN type IPv6 connection, which is rejected. Only one PDN connection is established. This is the second case, result a) described above.

FIG. 11 depicts a similar case to FIG. 9. The PDN type IPv4v6 request is not rejected, but only an IPv4 connection is accepted. The control logic 24 then requests a PDN type IPv6 connection, which this time is accepted.

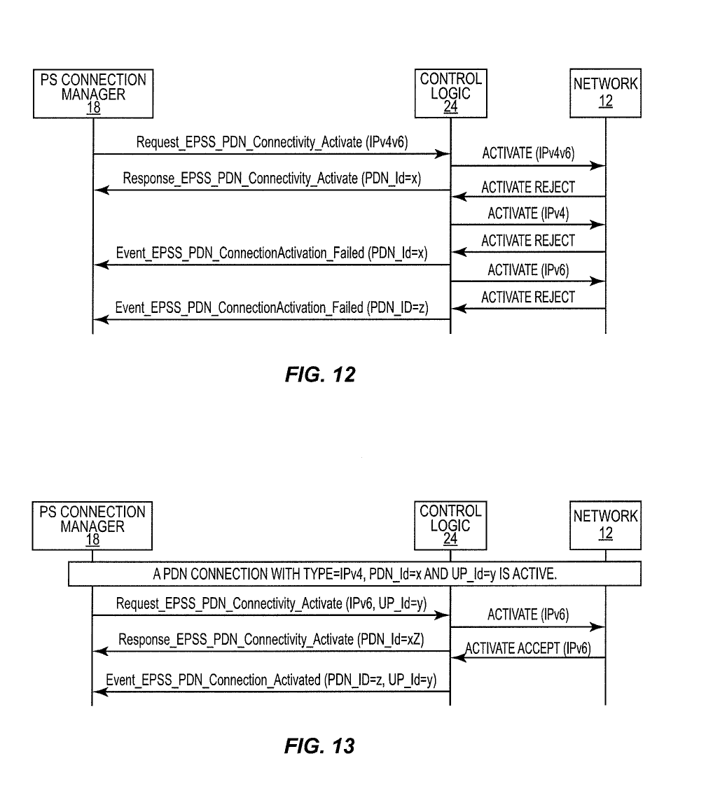

FIG. 12 depicts another case in which the PDN type IPv4v6 request is rejected. The control logic 24 then requests a PDN type IPv4 connection, which is also rejected. The control logic 24 then requests a PDN type IPv6 connection, which is also rejected. In this case (reject, reject, reject) no PDN connection is established.

FIG. 13 depicts a case in which the PS connection manager 18 requests a PDN type IPv6 connection, and further requests that it be linked to the same user plane endpoint as a previously-activated PDN type IPv4 connection. The control logic 24 accepts the request (since the requested and exiting connections are of different PDN types), and requests a new PDN type IPv6 connection. This is accepted, and an IPv6 connection is established. The control logic 24 links this PDN connection to the existing user plane endpoint of the PDN type IPv4 connection.

Regardless of the various possible PDN connection attempt success/failure scenarios, such as those described above, the control logic 24 eventually establishes PDN connections (if allowed) of all requested types, resulting in the scenario depicted in either FIG. 4A or 4B. In the case of FIG. 4A—that is, an IPv4v6 PDN connection to the network 12—both uplink to the network and downlink traffic to the mobile device 30 flow through the IPv4v6 PDN and network connections; operation in this case is straightforward. In the case of FIG. 4B—that is, separate IPv4 and IPv6 PDN connections to the network 12—downlink traffic from the network 12 to the mobile device 30 flows through the respective PDN connections, and routing all such traffic to the same IPv4v6 network connection to the IP stack 16 is straightforward. In the uplink, however, the IP stack 16 sends all traffic over the IPv4v6 network connection, but the control logic 24 must separate this traffic, routing it along the proper IPv4 or IPv6 PDN connection to the network 12.

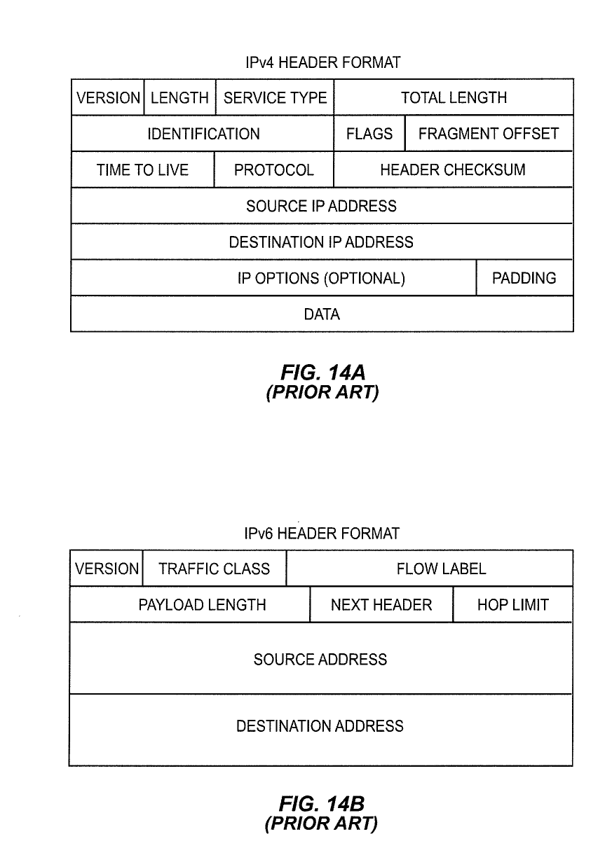

In one embodiment, the control logic 24 routes uplink traffic received from the IP stack 16 on a single IPv4v6 network connection to the proper IPv4 or IPv6 PDN connection to the network 12 by inspecting the version field of each IP packet. FIG. 14A depicts the header format for an IPv4 packet, and FIG. 14B depicts the header format for an IPv6 packet. In both cases, the version field is located in the first position in the header, and further it is the same size in both versions. The control logic 24 thus demultiplexes, or routes, individual IP packets received from the IP stack on a single IPv4v6 network interface to the appropriate network PDN connection in response to the contents of the version field of each IP packet header.

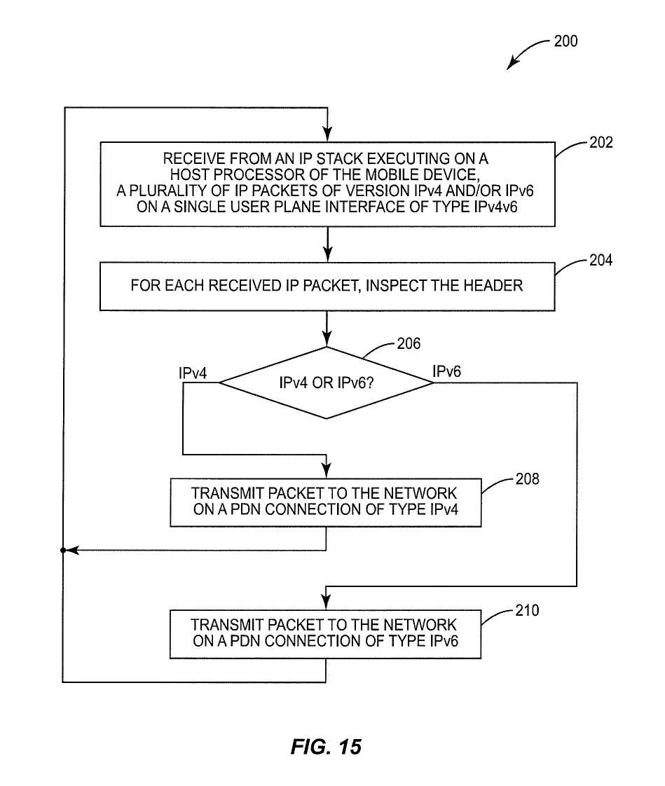

FIG. 15 depicts a method 200, executed by control logic 24 in the modem 20 of a mobile device 30, of routing uplink IP packets to a network 12, according to one embodiment. The control logic 24 receives a plurality of IP packets, of types, or versions, IPv4 and IPv6 on a single network connection to the IP stack of type IPv4v6 (block 202). For each received packet, the control logic 24 ascertains whether the packet is of version IPv4 or IPv6. In one embodiment, the control logic 24 ascertains this by inspection of the version field of the packet header (block 204). In response to the ascertained packet version (block 206), the control logic 24 then transmits IPv4 packets on an established PDN connection of type IPv4 (block 208), and similarly transmits IPv6 packets on an established PDN connection of type IPv6 (block 210).

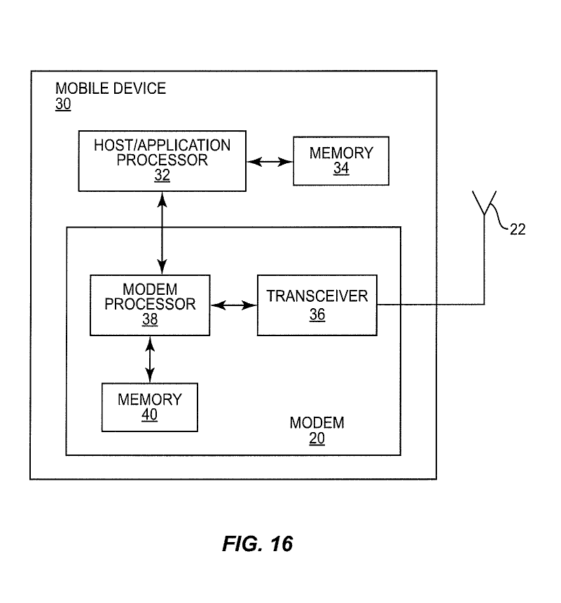

FIG. 16 depicts one representation of processing hardware of the mobile device 30, according to one embodiment. The mobile device 30 includes an application processor 32 (also known in the art as a host processor), operatively coupled to memory 34. The application processor 32 may comprise any sequential state machine operative to execute machine instructions stored as machine-readable computer programs stored in memory 34, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. The memory 34 may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like. Applications 14, the IP stack 16, and PS connection manager 18 may comprise software modules stored in memory 34 and executed on the application processor 32. Alternatively, one or both of the IP stack 16 and PS connection manager 18 may be implemented in hardware.

The modem 20 includes a transceiver 36 connected to the antenna 22, and operative to exchange data with a wireless network 12 according to a known protocol, such as one of the 3GPP protocols (e.g., GSM, LTE, WCDMA, or the like). The modem 20 also includes a modem processor 38 operative coupled to memory 40, which may comprise technology as described above. In one embodiment, the control logic 24 comprise one or more software modules stored in memory 40 and executed by the modem processor 38. In other embodiments, the control logic 24 may be implemented in hardware. Configuration data, such as the configuration parameter(s) controlling autonomous re-try behavior of the control logic 24, may also reside in memory 40.

The mobile device 30 may, of course, include additional hardware not depicted in FIG. 16 for clarity, such as user interface features (display screen or touchscreen, keypad, keyboard, microphone, speaker, camera, and the like); additional computational circuits (graphics, video, audio, cryptographic, compression, or similar dedicated processors); a battery an power management circuits; and the like.

The implementation of “dual-stack” functionality in control logic 24 of the modem 20 of a mobile device 10, as described herein, presents numerous advantages over conventional dual-stack configuration and operation. The complexity of handling IPv4v6 bearer management is highly reduced in the part of a mobile device 10 that supports the dual-stack operations, i.e. the part outside of the modem 20. If this is not the case, this complex functionality must be implemented in all host operating systems, including for example Android, iOS and Windows Mobile for smartphones, as well as various versions of operating systems in laptops and tablet computers, including for example Microsoft Windows, Linux, and Apple OS. Furthermore, the processing requirements are reduced when using only one user plane connection to handle dual-stack both for the host/application CPU and within the modem CPU.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method, performed in a modem of a mobile device, of establishing packet data network (PDN) connections with a wireless network, comprising:
receiving, from a packet switched connection manager executing on a host processor of the mobile device, a request to establish a PDN connection with the wireless network of PDN type IPv4v6;
in response to the request from the packet switched connection manager, transmitting a request for a PDN connection having a PDN type IPv4v6 to the wireless network;
establishing one or more PDN connections to the network, enabling the exchange of both IPv4 and IPv6 packets with the network; and
establishing a single user plane interface of PDN type IPv4v6 to an IP stack.

2. The method of claim 1 wherein establishing one or more PDN connections to the network comprises establishing a single PDN connection of type IPv4v6.

3. The method of claim 1 wherein establishing one or more PDN connections to the network comprises establishing a PDN connection of type IPv4 and a PDN connection of type IPv6.

4. The method of claim 3 wherein establishing a PDN connection of type IPv4 and a PDN connection of type IPv6 comprises:
receiving, from the wireless network, in response to the request for a PDN connection of type IPv4v6, a rejection of the request for a PDN connection having a PDN type IPv4v6; and
in response to the rejection, requesting a PDN connection of type IPv4 and subsequently requesting a PDN connection of type IPv6.

5. The method of claim 3 wherein establishing a PDN connection of type IPv4 and a PDN connection of type IPv6 comprises:
receiving, from the wireless network, in response to the request for a PDN connection of type IPv4v6, a rejection of the request for a PDN connection having a PDN type IPv4v6; and
in response to the rejection, requesting a PDN connection of type IPv6 and subsequently requesting a PDN connection of type IPv4.

6. The method of claim 3 wherein establishing a PDN connection of type IPv4 and a PDN connection of type IPv6 comprises:
receiving, from the wireless network, in response to the request for a PDN connection of type IPv4v6, an acceptance of a PDN connection specifying one of a PDN type IPv4 and a PDN type IPv6; and
in response to the acceptance, requesting a PDN connection of the other of a PDN type IPv4 and a PDN type IPv6.

7. A method, performed in a modem of a mobile device, of establishing linked packet data network (PDN) connections with a wireless network, comprising:
receiving, from a packet switched connection manager executing on a host processor of the mobile device, a request to establish a PDN connection with the wireless network, the request specifying one of a PDN type IPv4 and a PDN type IPv6, and further identifying an existing PDN connection having the other of a PDN type IPv4 and a PDN type IPv6;
in response to the request from the packet switched connection manager, transmitting a request for a PDN connection having the requested PDN type to the wireless network;
receiving, from the wireless network, an acceptance of the request for a PDN connection having the requested PDN type;
in response to the acceptance from the wireless network, establishing a new PDN connection having the same user plane endpoint to an IP stack as the existing PDN connection; and
sending to the packet switched connection manager an indication of the linked PDN connections with the wireless network.

8. A method, performed in a modem of a mobile device, of routing uplink data packets to a wireless network, comprising:
receiving, from an IP stack executing on a host processor of the mobile device, a plurality of IP packets of version IPv4 and/or IPv6 on a single user plane interface of type IPv4v6;
ascertaining, for each received IP packet, whether the packet is of version IPv4 or IPv6;
transmitting IPv4 packets to the network on a PDN connection of type IPv4; and
transmitting IPv6 packets to the network on a PDN connection of type IPv6.

9. The method of claim 8 wherein ascertaining whether a received IP packet is of version IPv4 or IPv6 comprises inspecting a version field of an IP header in the packet.

10. A mobile device operative to communicate via a packet switched wireless communication network, comprising:
a host processor executing a packet switched connection manager operative to initiate and manage packet data network (PDN) connections to the wireless network; and
a modem comprising a transceiver operative to transmit data to, and receive data from, the wireless network; and control logic operative to
receive, from a packet switched connection manager executing on a host processor of the mobile device, a request to establish a PDN connection with the wireless network of PDN type IPv4v6;
in response to the request from the packet switched connection manager, transmit a request for a PDN connection having a PDN type IPv4v6 to the wireless network;
establish one or more PDN connections to the network, enabling the exchange of both IPv4 and IPv6 packets with the network; and
establish a single user plane interface of PDN type IPv4v6 to an IP stack.

11. The device of claim 10 wherein the control logic is operative to establish one or more PDN connections to the network by establishing a single PDN connection of type IPv4v6.

12. The device of claim 10 wherein the control logic is operative to establish one or more PDN connections to the network by establishing a PDN connection of type IPv4 and a PDN connection of type IPv6.

13. The device of claim 12 wherein the control logic is operative to establish a PDN connection of type IPv4 and a PDN connection of type IPv6 by:
receiving, from the wireless network, in response to the request for a PDN connection of type IPv4v6, a rejection of the request for a PDN connection having a PDN type IPv4v6; and
in response to the rejection, requesting a PDN connection of type IPv4 and subsequently requesting a PDN connection of type IPv6.

14. The device of claim 12 wherein the control logic is operative to establish a PDN connection of type IPv4 and a PDN connection of type IPv6 by:
receiving, from the wireless network, in response to the request for a PDN connection of type IPv4v6, a rejection of the request for a PDN connection having a PDN type IPv4v6; and
in response to the rejection, requesting a PDN connection of type IPv6 and subsequently requesting a PDN connection of type IPv4.

15. The device of claim 12 wherein the control logic is operative to establish a PDN connection of type IPv4 and a PDN connection of type IPv6 by:
receiving, from the wireless network, in response to the request for a PDN connection of type IPv4v6, an acceptance of a PDN connection specifying one of a PDN type IPv4 and a PDN type IPv6; and
in response to the acceptance, requesting a PDN connection of the other of a PDN type IPv4 and a PDN type IPv6.

16. A mobile device operative to communicate via a packet switched wireless communication network, comprising:
a host processor executing a packet switched connection manager operative to initiate and manage packet data network (PDN) connections to the wireless network; and
a modem comprising a transceiver operative to transmit data to, and receive data from, the wireless network; and control logic operative to
receive, from a packet switched connection manager executing on a host processor of the mobile device, a request to establish a PDN connection with the wireless network, the request specifying one of a PDN type IPv4 and a PDN type IPv6, and further identifying an existing PDN connection having the other of a PDN type IPv4 and a PDN type IPv6;
in response to the request from the packet switched connection manager, transmit a request for a PDN connection having the requested PDN type to the wireless network;
receive, from the wireless network, an acceptance of the request for a PDN connection having the requested PDN type;
in response to the acceptance from the wireless network, establish a new PDN connection having the same user plane endpoint to an IP stack as the existing PDN connection; and
send to the packet switched connection manager an indication of the linked PDN connections with the wireless network.

17. A mobile device operative to communicate via a packet switched wireless communication network, comprising:
a host processor executing a packet switched connection manager operative to initiate and manage packet data network (PDN) connections to the wireless network; and
a modem comprising a transceiver operative to transmit data to, and receive data from, the wireless network; and control logic operative to
receive, from an IP stack executing on a host processor of the mobile device, a plurality of IP packets of version IPv4 and/or IPv6 on a single user plane interface of type IPv4v6;
ascertain, for each received IP packet, whether the packet is of version IPv4 or IPv6;
transmit IPv4 packets to the network on a PDN connection of type IPv4; and
transmit IPv6 packets to the network on a PDN connection of type IPv6.

18. The device of claim 17 wherein the control logic is operative to ascertain whether a received IP packet is of version IPv4 or IPv6 by inspecting a version field of an IP header in the packet.
